(19) United States
(12) Patent Application Publication
(10) Pub. No.: US 2008/0167960 A1
(43) Pub. Date: Jul. 10, 2008

(54) System and Method for Collective Response Aggregation

(75) Inventor: John M. Hughes, Hebron, CT (US)

Correspondence Address: Goodwin Procter LLP, Patent Administrator, 53 State Street, Boston, MA, 02109-2881, US

(73) Assignee: TOPCODER, INC., Glastonbury, CT (US)

(21) Appl. No.: 11/970,498

(22) Filed: Jan. 7, 2008

Related U.S. Application Data
(60) Provisional application No. 60/879,147, filed on Jan. 8, 2007.

(51) Int. Cl. G06Q 30/00; A63F 9/24

(52) U.S. Cl. 705/14; 463/9

(57) ABSTRACT

This invention relates to a system and methods for aggregated question answering by a number of entities, holding solutions competitions, and rewarding contestants who solutions are closest to the actual solution, and rewarding contestants who participate in competitions for their participation regardless of performance.

### TECHNICAL FIELD

This invention relates to prediction competitions and, more particularly, to methods and systems for facilitating aggregated response to questions.

### BACKGROUND INFORMATION

In the book, the “Wisdom of Crowds,” James Surowiecki describes an ability of a “crowd” to solve certain types of problems, such as cognition problems, which are problems with a definitive answer that people try to accurately assess after considering available and missing information. Examples of such problems may be the value of a company's equity at a particular time, the location of a sunken ship, or the number of books stored in a room. Surowiecki states that a group of reasonably well-informed and interested people can reach collective answer to problems that is more likely to be correct than any individual in the group. Surowiecki also states that the accuracy of the collective answer depends on the group's members having the qualities of diversity, such that they have different perspectives and opinions; independence, such that their answer does not depend on what other people think; and decentralization, such that the entities may have access to different, specialized knowledge, and a technique for aggregating the answer.

Some companies have implemented “information markets,” such as those described in U.S. Patent Application Publication 2002/0161696, published Oct. 31, 2002, in an effort to collect the opinions of corporate employees.

Others have tried to implement expert systems such as that described in U.S. Patent Application Publication 2006/0218179 to Gardner et al., which describes scoring predictions and determining the proficiency of a predictor. Such systems, however, are predicated on usefulness of identifying (and following) the predictions of a particular skilled individual.

### SUMMARY OF THE INVENTION

The disclosed technology provides a system and method for using the collective problem solving ability of a decentralized group to answer questions. Unlike some approaches, which attempt to identify, and give extra weight to, the input of more accurate responders, the disclosed technology treats contestants equally regardless of accuracy. At the same time, even without identifying and rewarding individual domain “experts,” the system motivates participation and provides incentives useful in obtaining answers.

In general, in one aspect, a method for facilitating aggregated question answering by a number of entities includes conducting a plurality of solution competitions. Each competition includes providing a problem and at least some information for solving the problem to a number of contestants. Each competition also includes receiving a solution from a plurality of contestants in answer to the question, and aggregating the received solutions such that the solutions received from each contestant are treated no differently than the solutions received from other contestants. Each competition also includes rewarding with a first reward one or more of the plurality of contestants whose received solutions are closer to the designated solution. The designated solution may be an actual answer or an aggregated answer, as designated at the time of providing the problem. The method also includes rewarding with a second reward contestants who participate in multiple competitions during a period of time in response to their participation in the multiple competitions during the period of time regardless of their performance in submitting solutions closer to actual solutions than other contestants.

In some embodiments, the first reward and the second rewards are monetary rewards. In other embodiments, they may be any sort of reward, including credits, accounts, services, goods, and/or privileges. The solution competition may be a competition to answer a particular question or series of questions. The questions may be designed such that the answers may be accurately aggregated. For example, the answers to the question or questions may be numeric. The problem may be a cognition problem.

Other aspects and advantages of the invention will become apparent from the following drawings, detailed description, and claims, all of which illustrate the principles of the invention, by way of example only.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention.

FIG. 1 is a block diagram of an embodiment of a distributed response aggregation system having a server according to the invention.

FIG. 2 is a diagram depicting an overview of the operation of an embodiment of the invention.

FIG. 3 is a flow chart depicting steps performed according to an embodiment of the invention.

### DETAILED DESCRIPTION

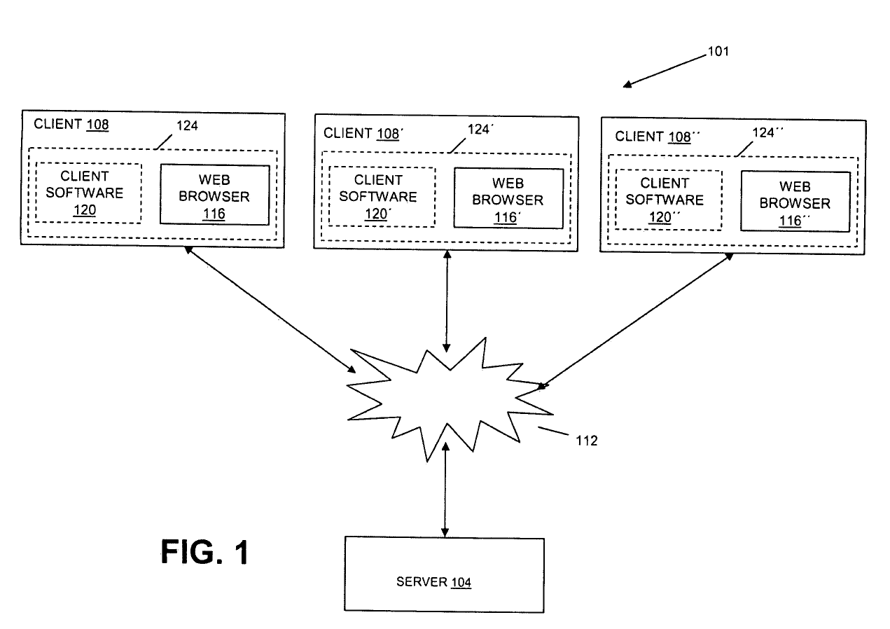

Referring to FIG. 1, in one embodiment, a distributed response system 101 includes at least one server 104, and at least one client 108, 108′, 108″, generally 108. As shown, the distributed response system includes three clients 108, 108′, 108″, but this is only for exemplary purposes, and it is intended that there can be any number of clients 108. The client 108 is preferably implemented as software running on a personal computer (e.g., a PC with an INTEL processor or an APPLE MACINTOSH) capable of running such operating systems as the MICROSOFT WINDOWS family of operating systems from Microsoft Corporation of Redmond, Wash., the MACINTOSH operating system from Apple Computer of Cupertino, Calif., and various varieties of Unix, such as SUN SOLARIS from SUN MICROSYSTEMS, and GNU/Linux from RED HAT, INC. of Durham, N.C. (and others). The client 108 could also be implemented on such hardware as a smart or dumb terminal, network computer, wireless device, wireless telephone, information appliance, workstation, minicomputer, mainframe computer, or other computing device, that is operated as a general purpose computer, or a special purpose hardware device used solely for serving as a client 108 in the distributed design development system.

Generally, in some embodiments, clients 108 can be operated and used by contestants to participate in various problem solving activities. Examples of such activities include, but are not limited to participation the problem solving projects described here.

Clients 108 can also be operated by entities (e.g., individual or corporate customers) who have requested that the contestants provide responses to particular questions. Such entities may use the clients 108 to review questions developed, post specifications for answers, view information about the contestants, as well as other activities described here. Clients 108 may also be operated by a facilitator, as an intermediary between customers and the contestants.

In various embodiments, the client computer 108 includes a web browser 116, client software 120, or both. The web browser 116 allows the client 108 to request a web page or other downloadable program, applet, or document (e.g., from the server 104) with a web page request. One example of a web page is a data file that includes computer executable or interpretable information, graphics, sound, text, and/or video, that can be displayed, executed, played, processed, streamed, and/or stored and that can contain links, or pointers, to other web pages. In one embodiment, a user of the client 108 manually requests a web page from the server 104. Alternatively, in another embodiment, the client 108 automatically makes requests with the web browser 116. Examples of commercially available web browser software 116 are INTERNET EXPLORER, offered by Microsoft Corporation, NETSCAPE NAVIGATOR, offered by AOL/Time Warner, or FIREFOX offered by the Mozilla Foundation.

In some embodiments, the client 108 also includes client software 120. The client software 120 provides functionality to the client 108 that allows an entity to participate, supervise, facilitate, or observe design development activities described above. An entity may be any person or persons acting for themselves and/or representing a business, corporation, partnership, etc. An entity also may be a computer or machine and/or assisted by a computer or other machine. The client software 120 may be implemented in various forms, for example, it may be in the form of a Java applet that is downloaded to the client 108 and runs in conjunction with the web browser 116, or the client software 120 may be in the form of a standalone application, implemented in a multi-platform language such as .Net or Java, or in native processor executable code. In one embodiment, if executing on the client 108, the client software 120 opens a network connection to the server 104 over the communications network 112 and communicates via that connection to the server 104. The client software 120 and the web browser 116 may be part of a single client-server interface 124; for example, the client software can be implemented as a “plug-in” to the web browser 116.

A communications network 112 connects the client 108 with the server 104. The communication may take place via any media such as standard telephone lines, LAN or WAN links (e.g., T1, T3, 56 kb, X.25), broadband connections (ISDN, Frame Relay, ATM), wireless links (802.11, bluetooth, etc.), and so on, and any combination. Preferably, the network 112 can carry TCP/IP protocol communications, and HTTP/HTTPS requests made by the web browser 116 and the connection between the client software 120 and the server 104 can be communicated over such TCP/IP networks. The type of network is not a limitation, however, and any suitable network may be used. Non-limiting examples of networks that can serve as or be part of the communications network 112 include a wireless or wired ethernet-based intranet, a local or wide-area network (LAN or WAN), and/or the global communications network known as the Internet, which may accommodate many different communications media and protocols.

The servers 104 interact with clients 108. The server 104 is preferably implemented on one or more server class computers that have sufficient memory, data storage, and processing power and that run a server class operating system (e.g., SUN Solaris, GNU/Linux, and the MICROSOFT WINDOWS family of operating systems). Other types of system hardware and software than that described herein may also be used, depending on the capacity of the device and the number of users and the size of the user base. For example, the server 104 may be or may be part of a logical group of one or more servers such as a server farm or server network. As another example, there may be multiple servers 104 that may be associated or connected with each other, or multiple servers could operate independently, but with shared data. In a further embodiment and as is typical in large-scale systems, the application software may be implemented in components, with different components running on different server computers, on the same server, or some combination.

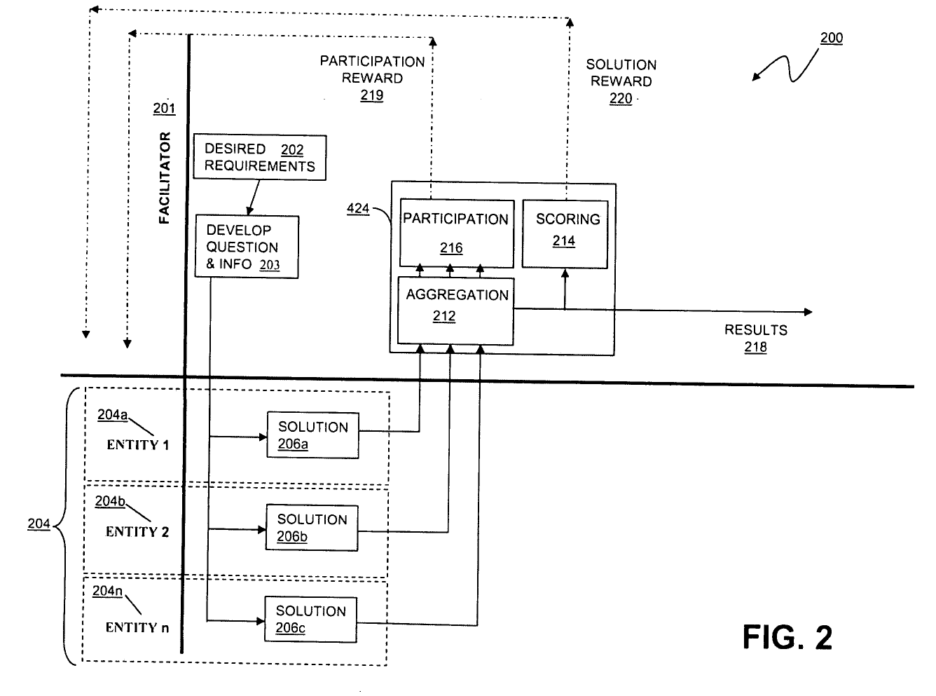

Referring to FIG. 2, in various embodiments, the server 104 and clients 108 enable response by a number of contestants, by providing an infrastructure 200 for motivating and facilitating participation. In some such embodiments, the aggregated question answering process is monitored and managed by a facilitator 201. The facilitator 201 may be the administrator that provides the aggregated response system, an entity who works for the administrator, or any individual, group, or entity capable of performing the functions described here. In some cases, the facilitator 201 may be selected from the distributed community of entities 204 based on, for example, participation in the infrastructure 200. In other cases, the facilitator 400 may be appointed or supplied by an entity requesting answers to questions.

Initially, the facilitator 201 receives input from an entity (not shown) wishing to have a question answered. The entity may be the facilitator itself, or an entity within the facilitator, or the entity may be for example, a company looking to have one or more questions designed and/or developed for internal use, or as portions of a larger research project.

The entity can be, for example, a company looking to obtain an answer to a particular question or set of questions. The entity can be, for example, a company that would like to gauge understanding as to the success of one of its products. The entity can be, for example, an investor who wants to know information about (e.g., sales revenue, product sales data, etc.) for a particular company. The entity can be, for example, a company that would like to obtain information about itself, its competition or another party.

In some cases, the interested entity itself develops requirements, e.g., questions to be answered 202, and generates 203 background information and a question or questions to be answered. In other cases, the facilitator receives the desired information 202 from the entity, and the facilitator develops 203 questions to be answered and develops appropriate background information through research or otherwise. For example, the requirements may describe only a company to be researched, and a general description of desired information, and the facilitator 201 may develop questions that, when answered, would provide insight into the problem described in the requirements.

In general, the completeness of the background information may be important in receiving quality answers, as there is a trade-off between the amount of background information provided, and the accuracy of the answers. For example, if not enough information is provided, the contestants will have no reasonable way to reach a conclusion. Significantly more information than is needed will add expense to the process, but also may be confusing. Thus, it may be important to develop the appropriate level of background information that will help contestants reach accurate conclusions. For example, if contestants are to determine the revenue of a particular retailer during a particular month, it may be helpful to provide statistics on the revenue for the previous month or months. Contestants may then measure their own diverse knowledge and experience against that number. If contestants are not provided with that information, they may not have sufficient basis for an answer, even if they have an opinion about whether they think the revenue will go up or down, and an estimate for about how much the change will be. On the other hand, providing very detailed accounting information may be counterproductive. Continuing the example, if a question about the change in revenue was asked as a percentage, less specific information about the revenue may be needed, although some context for how much revenue had changed over a time period may still be necessary or helpful.

Also generally speaking, in many cases, it may be helpful to develop questions that can be used to obtain an ultimate answer, rather than asking the contestants to perform complicated analysis. For example, rather than asking for determination of stock price, it may be fruitful to ask contestants to determine the revenue for a retailer, the costs for the retailer, and so forth. As mentioned above, it may require still less background information and knowledge to ask contestants to specify a percentage change in revenue, based on information that communicates revenue changes over time. The contestants can use their own experience and knowledge of the retailer to determine how they think the retailer's revenues will change over the time period. The facilitator can take the aggregated answer about the percentage change, and use that information to calculate the predicted revenue. Likewise, contestants can use their own experience and knowledge to determine how they think the costs of specific items will change, which can be fed back into a determination of financial condition of the business. Again, by designing indirect questions that may lead to conclusions about desired information, and that are more readily answered by the contestants, it becomes possible to make beneficial use of aggregated answers.

In general, the requirements may describe a problem to be solved, such as the answer to a particular problem, the value of particular data, or the result or the analyzed consequence of potential or actual changes to a system. Typically, the question is designed such that the answer may be easily aggregated. For example, a numeric response may be aggregated using statistical calculations such as mean, mode, and median, and/or other calculations such as moving average, statistical processing, and more.

The question may be accompanied by a specification of a reward for the entity (e.g., money, gift card, item, etc.) that submits the answer that is closest to the aggregated answer. In some cases, the reward may be a percentage, share, or other amount that is related to the benefit gained or derived from the information, or related in some way to that revenue. Relating the compensation to the revenue may motivate the participating entities to take the time to answer the questions appropriately.

Once complete, the question, background information, and reward information is distributed to one or more entities 204a, 204b, 204n (generally, 204), who may be members, for example, of a distributed community of entities. In one non-limiting example, the entities 204 are not related to each other. For example, the entities may have no common employer, may be geographically dispersed throughout the world, and in some cases have not previously interacted with each other. However, as members of the community, the entities 204 may have participated in one or more previous competitions, and/or have had previously submitted answers. Alternatively, in some embodiments, the group may be related, such as employees in a company, or members of an organization.

The communication can occur over a communications network such as the network 112 (FIG. 1), such as via an email, instant message, text message, a posting on a web page accessible by the web browser 116, through a news group, facsimile, or any other suitable communication. As mentioned, the communication of the question and background generally is accompanied by an indication of a prize, payment, or other reward to be given to the entity that submits the answer that is closest to the actual answer. In some cases, the amount and/or type of reward may change over time, or as the number of contestants increases or decreases, or both. In some cases multiple entities may be rewarded with different rewards, for example a larger reward for the closest, and a smaller reward for second place, third place, etc. The number of entities receiving a reward may be based on, for example, the number of entities participating in the competition, or other parameters.

The recipients of the question and/or background information may be selected by various means. In a preferred embodiment, the contestants are self-selecting, in that they are provided with notice of the competition, and those that believe that they have relevant information or skill to win are allowed to participate.

In some embodiments, members of the community may have expressed interest in participating in a competition, whereas in some cases the entities are selected based on previous participation in design competitions.

In one embodiment, the facilitator 201 moderates a collaborative forum among the various participants (the external entity, the entities 204, etc.) to determine, discuss, or collaborate on the questions and/or answers. Requests for clarification of a question or background information may be provided. In one embodiment, the collaboration forum is an online forum where participants can post ideas, questions, suggestions, or other information. In some embodiments, only a subset of the forum members, or only the facilitator 201 can post suggestions to the forum. In some embodiments, the collaborative forum is anonymous, so that the identity of a contestant is hidden from others. In some embodiments, an entity is identified by a randomly selected identifier, to hide their identity from others, in order to minimize the influence that contestants will have on each other, while facilitating the sharing of relevant information.

Upon receipt of the question and background information, one or more contestants submit a solution 206 to the question. The solution may be developed by any means. In some embodiments, tools may be provided to help with the development of a solution.

The contestants may provide an answer, for example, via a web site that receives the solution. The solution also may be provided by email, electronic messaging, through use of a client, and/or any other suitable means.

The solutions are provided to an aggregator 212, which collects the submitted solutions, and aggregates the solutions. In one embodiment, the responses provided by contestants are averaged, to reach an aggregated answer. The averaging may take place in one, two, or more dimensions, depending on the nature of the question asked. The averaging may be a mean, mode, or median or another calculation, for example, one or more statistical calculations, or some combination.

In one embodiment, the solution that is the closest to the actual answer may be selected as the winning solution. A reward is given to the entity who provided the winning solution. There also may be rewards for other solutions that are runner-ups. For example, the entities that submit the second and third best solutions may also receive payment, which in some cases may be less than that of the winning designer. In some embodiments, the entities can contest the score assigned to their design, program, or other submissions.

Use of the actual answer as a basis for determining the winner is possible when the question asked has an answer that will at some time, either at the time the question is asked or at some point in the future, be knowable or determinable. For example, if the question is what the share price of a particular market-listed stock will be at the close of the market on January 26, on January 26, at the close of the market, the winner(s) may be determined. Likewise, the number of babies born in Massachusetts during a particular month may be determined from census or other data. In general, the question statement will include information about what actual answer will be used. It should be understood that the “actual” answer need not be a precise actual answer, but may be only a mechanism for determining a winner, regardless of precision or accuracy.

In some embodiments, the solution(s) that are closest to the aggregated solution is/are selected as winning solution(s). In general, use of an aggregated answer for determining reward rather than the actual answer may be an alternative when an actual answer is and will not be available, however, in some cases, it may adversely affect the accuracy of the contestants, in that they may attempt to answer with what they perceive the other contestants will answer, rather than what the actual answer may be.

In one embodiment, the facilitator 201 uses a subscription model to offer entities access to the contest system. For example, for a fixed fee, an entity may have the opportunity to ask a certain number of questions directed to a particular topic. In another embodiment, entities may be charged on a per-question basis. In any case, in general, a portion of the fees paid by entities for access to the contestants will include the costs of the rewards for the winning solution, and rewards to contestants for their participation. In order to facilitate participation by the community of contestants, in may be helpful to schedule contests at regular times and dates. Subscribing entities may be encouraged to provide questions at regularly scheduled dates and times.

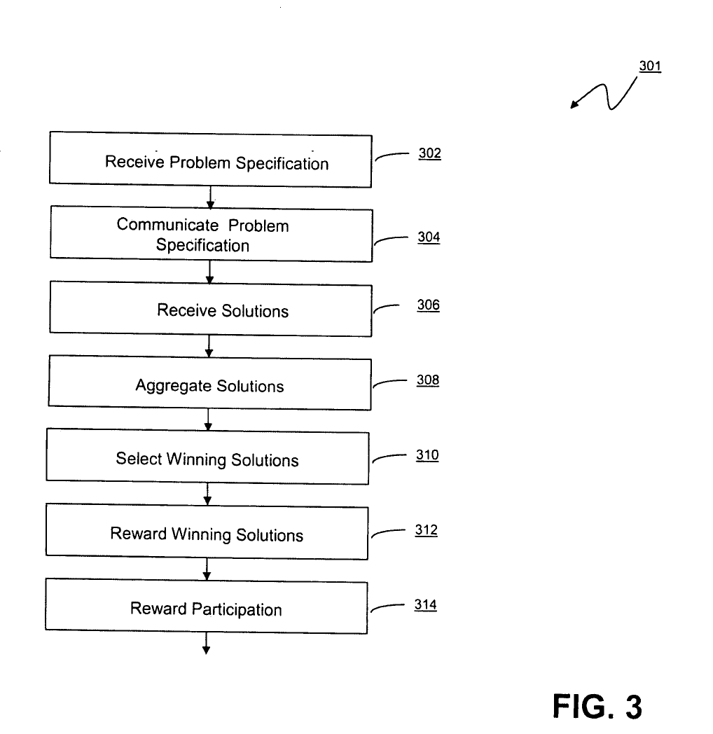

Referring to FIG. 3, a summary illustration 301 of an embodiment of a method for obtaining a solution includes a number of steps that may be performed in the order as shown or in a different order.

In an embodiment, the communication server 216 receives a package that includes a problem specification (STEP 302). The problem specification may include such information as a description of the problem, background factual information, reward(s) to be provided to the winners, timing deadlines for response, and so forth. For example, prizes may be awarded for first, second, and third place, or otherwise as described in the specification.

The problem specification is communicated to potential contestants (STEP 304). The specification can be communicated by posting to a web site that is accessed by members of the distributed community of problem solvers. The specification can be communicated via email, instant message (IM), or through any other suitable communication technique. The recipients of the specification can be selected by various means. In some embodiments, members of the community may have expressed interest in participating in a problem solving project, and in addition, in some cases, the entities may be selected based on previous participation, demographic information, or have demonstrated or claimed relevant domain knowledge.

Contestants solve, guess, or otherwise derive an answer to the problem, and once completed, the solution(s) are communicated to, and received at the server 104 (STEP 306). There may be a large number of responders, or a small group. There may be one question, a number of related questions, or a number of unrelated questions. There typically is a time period specified during which answers for particular question(s) will be accepted from contestants. This time period may be short (e.g., one or more hours) or longer (e.g., one or more days), depending on the questions and other circumstances.

The submitted solutions(s) are then subject to an aggregation process (STEP 308), in which an aggregated solution is obtained. The aggregation may be performed as described herein, or by some other suitable technique. For example, the aggregation may include a mean, mode, median or other such calculation, in one, two, or more dimensions.

In one embodiment, one or more responses are selected in response to the submitted solutions (STEP 310). In one embodiment, the solutions that are selected are the one or more solutions that are closest to the actual answer. For example, if the answer is a prediction, such as the interest rate published by a governmental entity on a particular date, the actual result on that date would be the answer. In another embodiment, which may be but is not necessarily an embodiment in which no actual answer is ascertainable, the solutions that are selected are the one or more solutions that are closest to the aggregated solution.

The winner(s) of the contest are rewarded (STEP 312). Typically, the reward(s) will be the rewards described in the question specification. In one embodiment, each entity has an account, and the award is deposited in the winner's account. Periodically, money is communicated from the accounts to the entities. In other embodiments, the awards are prizes, consumer goods, gift cards, credits, certificates, and so on.

In addition, one or more contestants are rewarded for their participation in one or more contests (STEP 314). In one embodiment, this additional award is not related to performance, but rather for participating. For example, in one embodiment, a contestant is awarded points for each contest in which the contestant participates, and an award given when the contestant has participated in enough contests to accumulate a certain number of points.

In some embodiments, each contest has access to the answers of the other contestants after such contestant has submitted his solution. In other embodiments, the answers are not available until after the competition. In some embodiments, the answers are not available until after it is possible to determine an actual answer, or some other time period or milestone has passed. In some embodiments, the results are not made available to the contestants. In some embodiments, the actual answers, if any, may be made available to the contestants, and in other embodiments, they may not be.

Although described here with reference to problems, and useful when implemented with regard to cognition problems, the question may be any type of question that is suitable for response and aggregation. Likewise, any sort of rewards, or motivator may be used to attract contestants to the contest, although preferably the motivation will encourage both participation and accuracy.

In one embodiment, the prize will be a percentage, share, or other amount that is related to the benefit gained from the information. For example, if a series of questions are directed to information that (directly or indirectly) indicate the immediate or future performance of a stock, bond, or other financial instrument, product, goods, commodity, currency, and so forth, and an investment position is taken based on the aggregated answer, a portion of the benefit of the position, such as a percentage of the gains, may be provided to the contestant or contestants who provided the closest answer or answers. The percentage may be a small or a significant portion of the benefit. Likewise, if a position is entered on goods or a commodity, and so forth, the winners may be provided with a portion of the benefit, instead of or in addition to other rewards. For large enough investments, the ultimate reward as a percentage of the benefit may be substantial. Generally, as described, this type of reward would be specified at the time that the question and background information was provided to the contestants.

Also, in some embodiments, it may be possible to “tune” the amount of background information that is provided with a particular type of question, based on the results received. In general, if aggregated answers are not accurate, it may be that there is not enough background information, there are not enough contestants, or the group of contestants is not diverse enough. In one embodiment, a facilitator provides a particular type of question with a certain amount of background information. The accuracy of the aggregated answer is determined. The same type of question is provided with additional background information, and a determination may be made about the accuracy of the second aggregated answer. If the accuracy has improved it may be, other factors being equal, that more background information is needed to obtain a more accurate answer to that type of question. Alternatively, it may be necessary to increase the award(s) or otherwise take steps to attract more contestants of the appropriate degree of diversity.

In some embodiments, it may be possible to predict the accuracy of an aggregated answer based on the accuracy of previous answers, and statistics regarding the similarity of the type question to previous questions answered, the amount of background information provided, the number and diversity of the contestants, and possibly other factors. This will permit the calculation of an accuracy index, to indicate a degree of confidence in the accuracy. Moreover, during a period in which a question is open for answering, if it appears that the contestant pool is not yet sufficient, it may be possible to increase one or both of the rewards, or to further advertise the availability of the contest to the appropriate demographic, so as to attract the appropriate contestants. In this way, it may be possible to obtain a more accurate answer.

Competition Server.

In some embodiments, a competition server provides a website that provides pages allowing users to register for a contest, view active contests, participate by answering questions for active contests, view historical contests and statistics related to historical contests, discuss the questions in competition-specific forums, and view help or FAQ content on the website. The website also has administration pages allowing administrators to create new competitions, add questions to new competitions, specify validation requirements for each question, specify correct answers for each question once the answers are known, and view results for each competition.

New User Registration.

In some embodiments, the contest server includes a set of pages to register a new user. The registration can use a step-by-step process to encourage sign-ups. For example, on the first page the user will supply a username and password, then move on to a second page to gather more information. Information to be provided by a user includes a username, also referred to as a handle, and a password. An email address and/or other contact data may be requested, and demographic data may be requested. A facility for updating user information also may be provided.

Active Contests Display and Selection.

In some embodiments, the contest server has a set of pages to view and participate in active contests. Several competitions may be running simultaneously, and the site will distinguish competitions for which the user has provided answers from those she has not, in order to facilitate participating in all active competitions. Each competition may have one or more of the following parameters: name, start date/time for the competition, end date/time for the competition, evaluation date/time (e.g., date/time when the winner may be determined), current number of submitters, and the first place reward. Users may click on one contest in a list of active contests to see more details about the contest and participate.

Contestants may submit an answer more than once, but only the last answer will be used. If a user has submitted multiple times, the user can see their submission history with their answers and the date/time that it was submitted. At the time that a user submits his or her first guess, they are asked to agree to the terms and conditions of the contest. If the contest contains multiple questions, the resubmission form will be pre-populated with their last submission answers to allow users to easily change only one or a few of their answers. User submissions will be validated based on the type of input expected, such as monetary value, integer, decimal value, etc.

In some embodiments, users cannot see the answers submitted by others. Users also can not see aggregate statistics until the contest has ended.

Completed Contests Information.

In some embodiments, the contest server system also includes a set of pages to view past contests and statistics related to past contests. In various embodiments, these pages may be available to the public, or restricted to contestants, or just to administrators. It may be possible to restrict access for some past contests to administrators, and access to other contests to registered contestants.

One the web pages, each past contest may have the following parameters: contest name, start date/time, end date/time, evaluation date, first place reward, winner name/handle, and number of submitters. For each question, details may include the average number of submissions per person, the average value for the answers, the median value for the answers, the standard deviation, the actual answer, and the winner.

A method for investing using aggregated question answering may include identifying desired information useful for making an investment, and specifying questions suitable for determining the desired investment information and that may be answered with aggregated question answering. For example, the desired information may be a cognition problem. The method also may include conducting one or more aggregated question answering competitions for obtaining answers to the specified questions. Each competition may include providing the specified question to a plurality of contestants and aggregating solutions received from each contestant. The method also includes rewarding with a reward one or more of the plurality of contestants who submitted a received solution. In some embodiments, in addition to the question, and at least some information useful for determining an answer to the question is provided.

In some embodiments, the method includes rewarding one or more of the plurality of contestants whose solution is closest to the actual solution. In some embodiments, the reward includes a monetary reward. In some embodiments, the reward is a commitment (direct or indirect) to a portion or percentage of the benefit gained from the desired information. In some embodiments, the answer may a numeric answer. The answer may be a relative value or a choice among multiple choices.

User Statistics.

In some embodiments, each user has a profile page that shows aggregate and detailed information for the contests they have participated in, such as the number of contests, the average placement, the number of wins, and the prize winnings.

Administration.

In some embodiments, the contest server includes administration pages for creating new competitions and adding questions to competitions. The competition parameters provided to the system for each competition includes the name of the competition, the start date/time, the end date/time, the evaluation date/time, the maximum number of submissions, question assignment and weight, and the rewards to be provided.

For each question in a contest, the information to be provided includes: the question text, the expected format for the answer (e.g., monetary, integer, decimal, and multiple choice), and categories and/or labels for the question. A multiple choice question will allows an admin to enter text for any number of selectable answers, which may be a radio button style (e.g., pick one), or checkbox (pick many). Questions may be assigned to groups for grouping similar questions. Questions can be assigned to groups for grouping similar questions, and labeled for categorization purposes.

The contest server may include a page allowing searching for questions based on labeling. The contest server may include a page for viewing detailed statistics and responses for both active and past contests. The contest server may include a page for allowing an administrator to specify the designated (e.g., actual) answer for a question once it is known. The system may then select the contestants that are the closest to the designated answer.

What is claimed is:

1. A method for facilitating aggregated question answering by a number of entities, comprising:
conducting a plurality of solution competitions, wherein each competition comprises:
providing a problem and at least some information for solving the problem to a plurality of contestants;
receiving a solution from a plurality of contestants in answer to the question;
aggregating the received solutions such that the solutions received from each contestant are treated no differently than the solutions received from other contestants; and
rewarding with a first reward one or more of the plurality of contestants whose received solutions are closer to the actual solution; and
rewarding with a second reward contestants who participate in multiple competitions during a period of time in response to their participation in the multiple competitions during the period of time regardless of their performance in submitting solutions closer to actual solutions than other contestants.

2. The method of claim 1, wherein the first reward and the second reward are monetary rewards.

3. The method of claim 1, wherein the first reward is a percentage of the benefit gained from the aggregated solution.

4. The method of claim 1, wherein the solution competition is a competition to answer a cognition problem.

5. The method of claim 1, wherein the answer is a numeric answer.

6. A computer-readable medium comprising instructions for implementing a method for facilitating aggregated question answering by a number of entities, comprising:
conducting a plurality of solution competitions, wherein each competition comprises:
providing a problem and at least some information for solving the problem to a plurality of contestants;
receiving a solution from a plurality of contestants in answer to the question;
aggregating the received solutions such that the solutions received from each contestant are treated no differently than the solutions received from other contestants; and
rewarding with a first reward one or more of the plurality of contestants whose received solutions are closer to the actual solution; and
rewarding with a second reward contestants who participate in multiple competitions during a period of time in response to their participation in the multiple competitions during the period of time regardless of their performance in submitting solutions closer to actual solutions than other contestants.

7. The computer-readable medium of claim 6, wherein the first reward and the second reward are monetary rewards.

8. The computer-readable medium of claim 6, wherein the first reward is a percentage of the benefit gained from the aggregated solution.

9. The computer-readable medium of claim 6, wherein the solution competition is a competition to answer a cognition problem.

10. The computer-readable medium of claim 6, wherein the answer is a numeric answer.

11. A method for investing using aggregated question answering, comprising:
identifying desired information useful for making an investment;
specifying questions suitable for determining the desired investment information and that may be answered with aggregated question answering;
conducting aggregated question answering competition for obtaining answers to the specified questions, wherein each competition comprises providing the specified question and at least some information for answering the question to a plurality of contestants and aggregating the received solutions such that the solutions received from each contestant, and rewarding with a reward one or more of the plurality of contestants who submitted a received solution.

12. The method of claim 11, further comprising rewarding one or more of the plurality of contestants whose solution is closest to the actual solution.

13. The method of claim 11, wherein the reward comprises a monetary reward.

14. The method of claim 11, wherein the reward is a percentage of the benefit gained from the desired information.

15. The method of claim 11, wherein the solution competition is a competition to answer a cognition problem.

16. The method of claim 11, wherein the answer is a numeric answer.
